(19) United States
(12) Patent Application Publication
(10) Pub. No.: US 2014/0027592 A1
(43) Pub. Date: Jan. 30, 2014

(54) Wall-Mounted Tether Archer Article

(71) Applicant: Blair Kusiak, Newtown, PA (US)

(72) Inventor: Blair Kusiak, Newtown, PA (US)

(21) Appl. No.: 13/940,350

(22) Filed: Jul. 12, 2013

Related U.S. Application Data
(60) Provisional application No. 61/674,937, filed on Jul. 24, 2012.

(51) Int. Cl. A01K 1/04; F16M 13/02

(52) U.S. Cl. CPC A01K 1/04; F16M 13/02
USPC 248/231.91

(57) ABSTRACT

A wall-mounted tether anchor is provided having an arcuate hook member surrounded by a perimeter ring, whereby the hook member supports the closed loop handle of a tether while the perimeter ring maintains the tether connection therewith by preventing lifting of the loop handle away from the hook. A threaded member extends from the base of the hook and provides a means to anchor the device into a wall surface. The threaded member comprises either a mechanical screw fastener or a threaded bolt member that can be placed through an open aperture and secured by way of a threaded nut. In an embodiment of the anchor device, the distal end of the hook does not extend far above the upper portion of the perimeter hook, whereby the otherwise exposed hook is bounded by the ring to reduce snagging or puncturing of articles pressing downward thereon.

### CROSS REFERENCE TO RELATED APPLICATION

This application claims the benefit of U.S. Provisional Application No. 61/674,937 filed on Jul. 24, 2012, entitled “Latchless Hook.” The above identified patent application is herein incorporated by reference in its entirety to provide continuity of disclosure.

### BACKGROUND OF THE INVENTION

1. Field of the Invention

The present invention relates to hook supports and hardware components. More specifically, the present invention pertains to a support hook device for securing a tether, wherein the device includes a perimeter ring surrounding an upright hook such that the closed loop handle of a tether or leash cannot easily dislodge from the hook, while at the same time the hook is shrouded to protect passersby from snagging concerns.

It is common for dog owners, groomers, and pet healthcare professionals to secure a dog using a dog leash, where the dog leash is attached to a support to maintain the dog's position while engaging in other activities. These activities include grooming, health checkups, and periods where the dog is left alone momentarily and the handler wishes the dog to remain in one location. Generally the dog leash is attached to a hardware article mounted on a wall or along another type of support, wherein one end of the leash is supported while the opposing end attaches to the dog's collar.

The most inexpensive and readily available of these hardware articles are hardware hooks, while include an arcuate member secured to the wall using a wall anchor or similar attachment means. Conventional hooks, however, make poor leash supports. Generally the hand loop of the leash is placed on the end of the hook, whereby pulling motion from the dog on the leash is resisted as the hook snares the leash loop. However, it is not difficult to separate the leash loop from the hook structure with repeated attempts, where the leash can reposition itself with regard to the hook during periods of tensioning and slacking.

Eventually the leash can become dislodged and allow the dog to roam freely in the given space or escape altogether from the handler or owner's care. A loose animal may run into traffic, create havoc or injury inside a veterinary facility waiting area, attack another individual in close proximity causing injury and possible legal action, cause injury to animal hospital staff or animal patients in treatment, or further cause physical and mental stress for the escaped animal's handler and onlookers.

To avoid these potential situations, leash hooks having a securement latch thereover are available for more securely supporting a conventional dog leash handle loop. These devices, however, also have drawbacks that limit their usefulness. These devices require a dog owner or handler to utilize both hands to free the leash from the hook latch, which can be difficult when handling other object or altogether difficult with a rambunctious pet. Such a device may actually increase the chances that an animal on-leash will escape once the leash is freed and the owner is momentarily switching hands between the latch and the leash.

The present invention provides a conventional hook hardware article that further comprises a rounded perimeter ring that surrounds the hook. The ring is utilized to maintain the position of the leash loop in a downward position with respect to the upstanding hook, whereby the leash loop cannot be lifted above the hook or through its open hook upper. This allows a leash to be readily attached to the hook after first being fed through the perimeter ring from the underside. Tension on the leash is reacted by the hook and the leash bears against the perimeter ring to maintain a stable support configuration.

By surrounding the hook itself, the hardware article is also provided with an ancillary benefit: the otherwise exposed hook is shrouded by the ring such that a falling object cannot readily be snared or punctured by the hook distal end. In both residential and commercial settings, an exposed hook on a wall can be a dangerous object, posing a risk of puncture or snagging for passersby. Those that may slip or fall near the exposed hook are subjected to the possibility that the user's hand or body may be punctured by the exposed hook. The perimeter ring of the instant invention prevents the exposed hook from embedding into an object, as the ring simultaneously bears against the object and prevents any entry thereinto. In this way, the present invention provides a dual purpose hardware element.

Along with animal leashes and protecting bystanders from snagging concerns, the present invention is herein contemplated for use in securing any generic tether, rope, or elongated article having a closed end or knotted end. Specifically, the device is contemplated for supporting boat tethers, clothes lines, and various ropes or lines for project use. The device allows the looped or closed end of a tether to be securely supported without readily disconnecting from the hook, as would occur with an exposed hook hardware article.

2. Description of the Prior Art

Devices have been disclosed in the prior art that relate to animal tether hardware and support devices. These include devices that have been patented and published in patent application publications, and generally relate to hardware articles of varying and diverging structure as it relates to the present invention. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 3,658,037 to Hunter discloses a ground stake device for securing an animal tether, whereby the device comprises a closed loop connector secured to a cylindrically shaped rod that is adapted to penetrate the ground surface. The rod is telescoping and the connector provides an upstanding hardware element for connecting a leash or similar animal tether when the rod is placed into the ground. While disclosing a rounded hardware article that extends from a support surface to support an animal leash, the Hunter device fails to disclose the novel structural elements of present invention, notably the combination of hook and perimeter ring that are securable into a wall surface.

Another such device is U.S. Pat. No. 7,650,673 to Jeffers, which discloses a rope tie for an animal tether, wherein the structure includes a wall-mounted helical coil that allows the rope to be positioned through the helical structure for support therefrom. The coil has a first and second consecutive loop, whereby rope attached to an animal or boat can be passed through the first coil and secured over the second coil. When pulled, the rope plays out of the coil and tightens around the bottom portion of the second loop. The Jeffers device, as with the Hunter device, fails to disclose the structure and functional characteristics of the present invention, which is notably an arcuate hook member bounded by a perimeter ring to secure a leash loop positioned on the hook.

U.S. Pat. No. 3,233,934 to Osborn discloses a rope anchor having a body that includes a pair of elongated guide members disposed apart from one another and form into a V-shaped notch. A closed loop extends outward from the V-shaped notch, whereby rope can be fed therethrough and around the notch along the body guide members to secure the rope thereto. The Osborn device operates in a similar manner as the present invention, but provides a diverging structure that includes an enlarged base member and a curving structure that forms the upstanding V-shaped notch. The present invention is largely confined within the plane of the perimeter ring, wherein the arcuate hook exits that plane only minutely as compared to the larger Osborn structure. The Osborn structure further would not function as a functional safety hook device, as the upstanding portion of the V-notch is quite exposed for snaring and hooking passersby.

U.S. Pat. No. 3,960,091 to Ehlert discloses a rope hook mount for a vehicle comprising a circular body portion having an open interior, wherein the backside of the circular body conforms to the attached vehicle. A lip member extends radially inward from the circular body, wherein a portion of rope may be secured behind the lip member and against the circular body to prevent dislodgment of the rope. The Ehlert device is useful for interlacing rope through its structure, but would not be suitable for supporting the loop of an animal leash. A curved hook member is required to support the leash loop, while the perimeter loop retains the loop on the hook and prevents the loop from lifting from the hook interior.

Finally, U.S. Pat. No. 6,684,613 to Blocker discloses another animal tether device that comprises a ring-shaped frame having an open space therein, and a retention member extending from the frame. The retention member includes a bend to urge the lead line to a location spaced from the central region of the retention member when the lead line is interlaced through the frame and around the retention member. The present invention provides a hook bounded by a perimeter ring, wherein the hook curves below the ring and then at least up to the plane upon which the ring lies. The present invention is further directed to a wall anchor device rather than a tethered hardware article.

The present invention provides a readily securable tether support, tether support, and safety hook that is wall-mountable for retaining the position of the tether closed end while unattended. The device allows a user to place the loop handle of the tether within the hook, while the perimeter ring prevents the loop from lifting out of the hook based on tension in the tether along. A lifting force at the loop location is required to separate the loop from the hook and feed the loop out of the perimeter ring. It is submitted that the present invention is substantially diverges in design elements from the prior art and consequently it is clear that there is a need in the art for an improvement to existing tether anchors and safety hook hardware articles. In this regard the instant invention substantially fulfills these needs.

### SUMMARY OF THE INVENTION

In view of the foregoing disadvantages inherent in the known types of tether anchors and safety hook devices now present in the prior art, the present invention provides a new hardware article that can be utilized for providing convenience for the user when securing a tether having a closed loop handle, while further providing a hook structure that has an enclosing perimeter ring to prevent puncture or snaring concerns.

It is therefore an object of the present invention to provide a new and improved tether anchor and safety hook device that has all of the advantages of the prior art and none of the disadvantages.

It is another object of the present invention to provide a tether anchor that secures to a wall and provides a stable anchor point for a looped tether that will not release the tether without human assistance.

Another object of the present invention is to provide a tether anchor that includes a threaded member that fastens the device into a support wall, wherein the member can drive into a support wall or the threaded member can be a bolt that clamps a support wall between two opposing nuts.

Yet another object of the present invention is to provide a tether that is particularly suited for a tether having a closed-loop handle end, wherein the loop is placed into the arcuate hook region and bounded by the perimeter ring, preventing separation of the handle and the hook during use.

Another object of the present invention is to provide a tether anchor that also serves as a safety hook device, wherein an otherwise exposed hook hardware member is surrounded by a perimeter ring to reduce snagging and possible puncture from the hook distal end while deployed.

Another object of the present invention is to provide a tether anchor that is simple in construction and one that is readily deployed for use supporting an animal on a leash or a boat attached to a mooring line.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal perspective view of the present invention.

FIG. 2 shows a side perspective view of the present invention.

FIG. 3 shows an overhead view of the present invention.

FIG. 4 shows a perspective view of the present invention in a working state, supporting the loop handle of a dog leash along a wall surface and further supported by a mounting plate.

### DETAILED DESCRIPTION OF THE INVENTION

Reference is made herein to the attached drawings. Like reference numerals are used throughout the drawings to depict like or similar elements of the tether anchor and safety hook device. For the purposes of presenting a brief and clear description of the present invention, the preferred embodiment will be discussed as used for securely supporting a tether for periods of time, wherein repeated tension on the tether will not separate the tether from the hook while the perimeter ring prevents any upward riding of the tether on the hook while in use. The figures are intended for representative purposes only and should not be considered to be limiting in any respect.

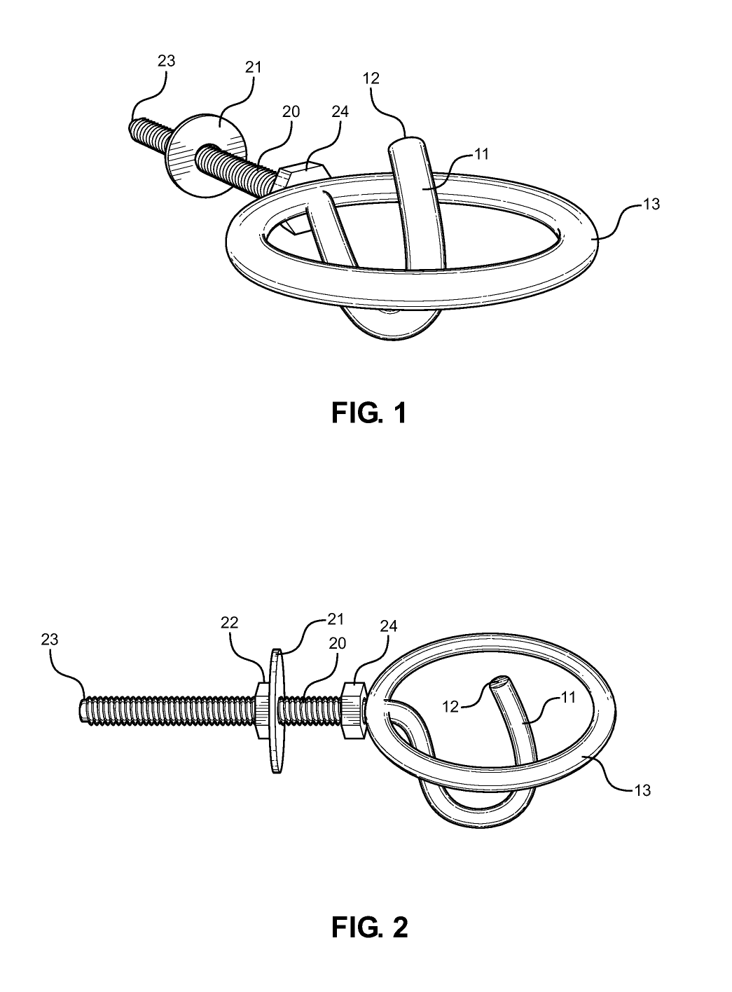

Referring now to FIGS. 1 and 2, there are shown perspective views of the tether anchor device of the present invention. The device is a hardware article that comprises a first elongated threaded member 20 having either a pointed or square distal end 23 such that the threaded member 20 may act as a drive screw or a threaded bolt member. Attached to the proximal end of the threaded member 20 is an arcuate hook member 11 that extends downward from the threaded member 20 and then curves upward until terminating 12 at a point thereabove. Surrounding the threaded member 20 and also extending from the threaded member proximal end is a perimeter ring 13 that creates an enlarged circular shape having an open interior to accommodate the hook member 11. The ring 13 remains largely in the same plane as the threaded member 20, while the hook extends slightly below and slightly above this plane.

The threaded member 20 is an elongated attachment means that may be provided as either a drive screw or a threaded bolt member. As a drive screw, the threaded member 20 includes a sharpened distal end for driving into a wall surface as the threads secure the member within the wall. This arrangement is well understood in the art of mechanical screw fasteners. As a bolt member, the threaded member 20 provides a means to rotatably support at least one threaded nut 24, 22 therealong so as to clamp a support surface therebetween or between the nut 22 and the member proximal end. A washer element 21 may further be provided to spread the load along a wall surface.

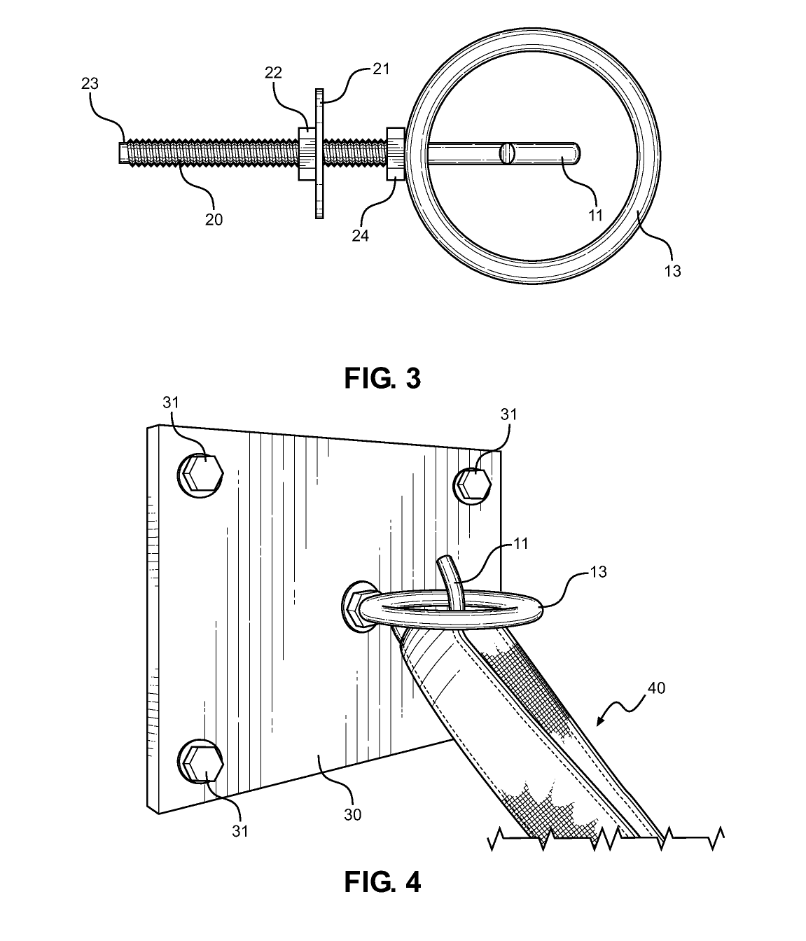

Referring now to FIG. 3, there is shown an overhead view of the present invention. From this view, it is clear the relation between the arcuate hook member 11 and the perimeter ring 13, wherein the ring provides an outer boundary within which the hook 11 resides. The hook 11 is adapted to support the closed loop handle of a tether (e.g. a dog leash, boat mooring line, etc.), wherein the tether closed loop end is fed through the ring from the underside and looped over the open upper portion of the hook 11 so as to reside within the interior of the arcuate hook. The ring 13, therefore, prevents the tether handle from riding upwards along the hook 11 and thus separating the tether from the hook 11, which would otherwise be accomplished by consecutive tugging sessions or if the tether were able to raise or otherwise lift the handle out of the hook 11. The ring 13 maintains the downward position of the tether and maintains tension against the hook 11, wherein the tether can only readily be removed through user assistance.

Referring now to FIG. 4, there is shown a view of the present invention in a working position, mounted along a wall surface and supporting a tether therefrom. When in operation, the closed loop handle 40 of the tether is fed through the perimeter ring 13 interior from below and in an upward direction, whereafter the loop handle 40 is positioned over the hook member 11 and tensioned therefrom. The tether rests from the hook while the opposite end attaches to an animal or boat to maintain the position thereof adjacent to the hook mounting location along the wall. When the tether is tugged, it will tension and will ride slightly upward along the curved hook member 11. The perimeter ring 13 however, will arrest this upward progression and prevent the tether handle from lifting completely from the hook 11 and separating therefrom.

Also show in FIG. 4 is a particular mounting arrangement wherein the device is placed through a wall and through a mounting plate 30. The mounting plate 30 is simply a means to spread the tension load along the threaded member along the wall and thus preventing pull-through of the threaded member from the wall surface. The mounting plate 30 may be fastened 31 to the wall, or alternatively the device may be fastened directly to the wall surface itself without the use of the mounting plate.

A secondary use for the present hardware article is for general hook use, wherein the present structure provides such a hook but also provides a perimeter ring that acts as a safety feature to prevent snagging or puncture of articles or appendages of passersby. In this embodiment, the distal end of the hook does not extend far above the plane of the perimeter ring upper extreme, thereby reducing the amount of freely exposed hook length that could otherwise snag or puncture an article if it were to fall thereonto. The perimeter ring therefore acts as a secondary support shelf, which adds safety to an otherwise hazardous hardware article that is freely exposed from a wall surface (e.g. a bare hook). It is contemplated that the present invention may be provided for supporting an animal leash, a boat mooring line, or any other rope or tether having a closed loop end or tied end.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wall-mounted hardware article, comprising:
an elongated threaded member having a distal and proximal end;
a perimeter ring connected to said threaded member proximal end and positioned in the same plane as said threaded member, said perimeter ring having an open interior;
an arcuate hook member extending from said threaded member proximal end and positioned within said perimeter ring open interior;
said hook member extending below said perimeter ring and curving upwards until terminating.

2) The device of claim 1, where said hook termination extends just above said perimeter ring upper extreme to prevent puncture or snaring risks of said hook termination.

3) The device of claim 1, wherein said threaded member distal end comprises a pointed tip to provide a drive screw fastener.

4) The device of claim 1, wherein said threaded member supports at least one threaded nut therealong.
